(19) United States
(12) Patent Application Publication
(10) Pub. No.: US 2017/0180746 A1
(43) Pub. Date: Jun. 22, 2017

(54) VIDEO TRANSCODING METHOD AND ELECTRONIC APPARATUS

(71) Applicants: LE HOLDINGS (BEIJING) CO., LTD., Beijing (CN); LECLOUD COMPUTING CO., LTD., Beijing (CN)

(72) Inventors: Xingyu LI, Beijing (CN); Wei WEI, Beijing (CN); Hai QI, Beijing (CN); Zhi BIAN, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/247,721

(22) Filed: Aug. 25, 2016

Related U.S. Application Data
(63) Continuation of application No. PCT/CN2016/088649, filed on Jul. 5, 2016.

(30) Foreign Application Priority Data
Dec. 22, 2015 (CN) 201510969643.1

(51) Int. Cl. H04N 19/40; H04L 12/26; H04L 29/06

(52) U.S. Cl. CPC H04N 19/40; H04L 63/0428; H04L 43/16; H04N 19/172

(57) ABSTRACT

Disclosed is a video transcoding method which enhances the efficiency of segmentation transcoding, including: performing frame rate conversion analysis on a video to obtain result information of frame rate conversion and position information of an IDR frame, and dividing the video into first video clips according to the position information of the IDR frame; splicing all the first video clips to produce second video clips according to chronological order and preset rule; encoding all the second video clips to obtain statistical file of the video according to the result information of frame rate conversion; determining scene switching position of the video according to predetermined frame type of the statistical file; splicing all the first video clips to produce third video clips according to the scene switching position; encoding and splicing all the third video clips to produce a complete video file according to the result information of frame rate conversion.

### CROSS REFERENCE TO RELATED APPLICATIONS

This application is a continuation of International Application No. PCT/CN2016/088649, filed on Jul. 5, 2016, which is based upon and claims priority to Chinese Patent Application No. 201510969643.1, filed on Dec. 22, 2015, the entire contents of which are incorporated herein by reference.

### TECHNICAL FIELD

The disclosure relates to a video technological field, more particularly to a video transcoding method and an electronic apparatus.

### BACKGROUND

Transcoding is a very important step in the video industry. Each video needs to be transcoded before uploaded, or a too large video source will occupy a user's bandwidth too much. Every day there are thousands of videos needing to be transcoded, and thus, the transcoding efficiency is very important. How to enhance the transcoding efficiency and shorten transcoding time is usually a research direction in the video filed.

To divide and then transcode videos is a good solution, and however, such a solution in the modern industry usually belongs to the transcoding of physical video clips. The transcoding of physical video clips not only has some problems in video clips, where related video contents may be allocated to different clips and the enhancement of performance is also limited.

Physical video clip scheme nowadays are dividing a video into a number of clips that are small independently-encapsulated videos. Whenever these small videos need to be transcoded, they will be subjected to decapsulation, decoding, and encoding once, sequentially.

### SUMMARY

Accordingly, the disclosure provides a video transcoding method and an electronic apparatus to resolve the technical problem in the art where the efficiency is low as a video file is divided into physical video clips and then encoded.

To resolve the above technical problems, an embodiment of the disclosure provides a video transcoding method, including:
performing frame rate conversion analysis on video to obtain result information of frame rate conversion and position information of an IDR frame, and dividing the video into a plurality of first video clips according to the position information of the IDR frame; splicing all the first video clips to produce a plurality of second video clips according to chronological order and preset rule; encoding all the second video clips to obtain statistical file of the video according to the result information of frame rate conversion; determining scene switching position of the video according to predetermined frame type of the statistical file; splicing all the first video clips to produce a plurality of third video clips according to the scene switching position; encoding and splicing all the third video clips to produce a complete video file according to the result information of frame rate conversion.

An embodiment of the disclosure provides a non-volatile computer storage medium storing computer executable instructions used to perform the above video transcoding method.

To resolve the above technical problems, the disclosure provides an electronic apparatus of video transcoding, including: a processor; a memory configured to store instructions executable by the processor; wherein the processor is configured to: perform frame rate conversion analysis on a video to obtain result information of frame rate conversion and position information of an IDR frame, and dividing the video into a plurality of first video clips according to the position information of the IDR frame; splice all the first video clips to produce a plurality of second video clips according to chronological order and preset rule; encode all the second video clips to produce statistical file of the video according to the result information of frame rate conversion; determine scene switching position of the video according to predetermined frame type of the statistical file; splice all the first video clips to produce a plurality of third video clips according to the scene switching position; encode and splice all the third video clips to produce a complete video file according to the result information of frame rate conversion.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of an embodiment of the disclosure.

FIG. 2 is a flow chart of another embodiment of the disclosure.

FIG. 3 is a flow chart of another embodiment of the disclosure.

FIG. 4 is a flow chart of another embodiment of the disclosure.

FIG. 5 is a structural diagram of the Embodiment 10 of the disclosure.

Numeral labels in each figures have meanings listed by: 100 representing a video transcoding device; 1 representing a video processing module, 2 representing a first splicing module, 3 representing a first encoding module, 4 representing a determining module, 5 representing a second splicing module, 6 representing a second encoding module, 210 represents a processor, 220 represents a memory, 230 represents an input device, and 240 represents an output device.

### DETAILED DESCRIPTION

### Embodiment 1

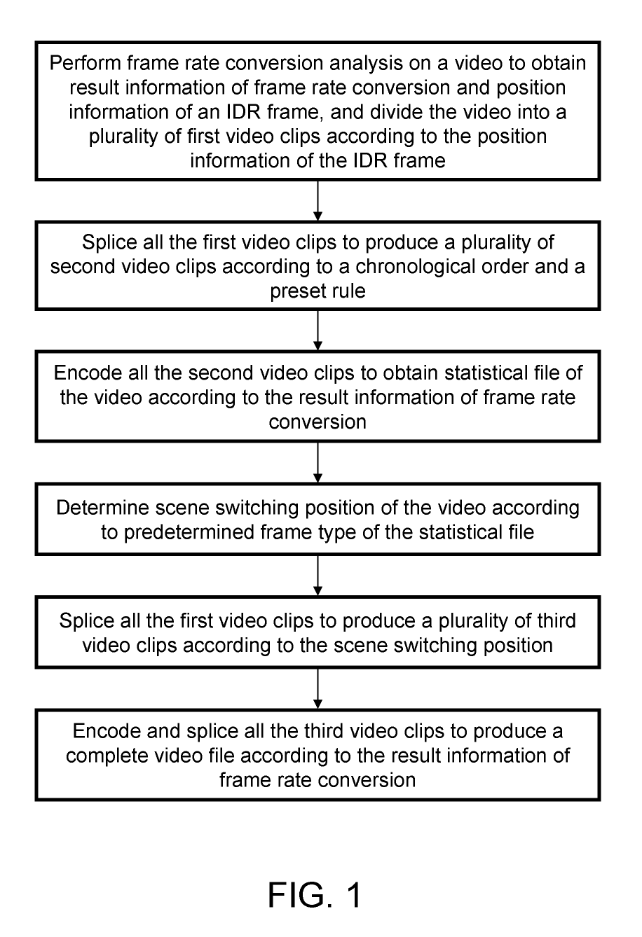

In this embodiment, a video transcoding method, as shown in FIG. 1, includes:
firstly, performing frame rate conversion analysis on a video to obtain result information of frame rate conversion and position information of an IDR frame, and dividing the video into a plurality of first video clips according to the position information of the IDR frame; for example, video source enters into a decapsulation unit, in which the video source will fully scan once, be decapsulated (i.e. a container is removed from a bare code flow). Then, storage starts in an IDR frame (key frame) and ends in a next IDR frame (key frame), the others can be deduced by analogy, and finally, a number of clips of the bare code flow are produced. Meanwhile, the comparison of timestamps is also done to calculate the position information of inserting and discarding a frame during the frame rate conversion analysis.

Since the IDR frame is a first frame of a current physical video clip of the video, the first video clips are current physical video clips of the video. In some situations, after current physical video clips of the video are is initially clipped, the frame rate conversion analysis is performed on the video to obtain the result information of frame rate conversion and the position information of the IDR frame, and the video is divided into a plurality of first video clips according to the position information of the IDR frame. For example, current physical video clips of a video having a time length of 6 seconds per clip is divided to have a time length of 2 seconds per clip, and then the first frame with 2 seconds per clip is still an IDR frame; and the video can be divided into a plurality of first video clips according to the position information of the IDR frames after further division, and these first video clips are physical video clips that are generated by further dividing primary physical video clips of the video.

The position of an IDR frame is a start position of a current physical video clip of the video. As compared to an I frame, the head of an IDR frame further includes a sequence parameter set (SPS) and a picture parameter set (PPS), the two network abstract layer units (NALU), and a separation sign. For example, “00 00 00 01 67 43 00 1F 00 00 00 01 68 CE 07 F2”, where “00 00 00 01” represents a separation sign, “67 43 00 1F” represents SPS, “68 CE 07 F2” represents PPS, encoding “67″via a preset encoding conversion method can correspond to the NALU type ID of the SPS, and encoding “68″via a preset encoding conversion method can correspond to the NALU type ID of the PPS. Because the decoder immediately clear the decoded picture buffer (DPB) while decoding an IDR frame, the SPS and PPS further include parameter information used to initialize the decoder again.

The IDR frame will cause that DPB is cleared but the I frame will not. The IDR frame must belong to the I frame, but the I frame can belong or not belong to the IDR frame. An image sequence can have many I frames, frames following an I frame can use the images between the I frames as a motion reference, and a B frame and a P frame behind a general I frame can use other I frames before this I frame. A player always plays a randomly-accessed video stream from an IDR frame because no frame behind this IDR frame will use previous frames. However, it is impossible to start playing a video with no IDR frame from any point because following frames always use previous frames.

After the position of the IDR frame in a code flow of the video is recognized, the IDR frame is used to divide the video into a plurality of first video clips, and the first video clips are physical video clips of the video and can be considered a kind of clips of the video. It is not necessary to practically divide the video, but it is only needed to divide the video code flow according to the IDR frame. In the process of splicing the first video clips to produce a plurality of second video clips, splicing the first video clips is only needed. Such a manner has the advantages that there is no need to divide the video before splicing and encoding processes, it is only needed to combine these clips, and the combination time is fewer than the time of division. Division performed in the position of IDR also stems from the feature of video decoding, which starts decoding from IDR, so as to ensure the proper decoding.

Then, all the first video clips are spliced to produce a plurality of second video clips according to the chronological order and a preset rule. The preset rule may be a preset threshold of the number of spliced first video clips, or may be a preset threshold of the total size of the spliced first video clips. Whenever such a threshold is exceeded, splicing clips will be stopped and one second video clip will be formed, so that all the first video clips are spliced to produce a plurality of second video clips. For example, when the first video clips are being spliced, they can be spliced according to the chronological order of timestamps of decoding; and whenever the number of spliced first video clips arrives 10 or whenever the total data size of the spliced first video clips is more than or substantially equal to 20 MB, the spliced first video clips will be considered one second video clip.

If the number of spliced first video clips or data exceeds a preset threshold, it is possible that there are too much spliced frames. The too much number of spliced frames will cause a too long time of transcoding each second video clip, and this means that the advantage of segmentation transcoding is not used well, and is disadvantageous to the enhancement of the entire transcoding efficiency. Therefore, it is necessary to limit the number of spliced first video clips or the data size of the spliced first video clips.

Next, all the second video clips are encoded according to the result information of frame rate conversion, and inserting or discarding a frame is done in a related position to obtain a statistical file of the video. This encoding belongs to single-pass encoding (1 pass encoding), where before encoding starts, the video is not outputted but a statistical file (stats file) is generated to record the video's bitrate change, quantified parameter, forecast information of scene change, or the like. The statistical files corresponding to all the second video clips are combined into a statistical file corresponding to the whole video. For example, in the case of a x264 video encoder of H.264 video encoding standard, the 1pass encoding has a constitution including: “--stats “log.stat” --output NUL “input.avi”” representing to input a video and output a statistical file rather than the video; “--qpmin 0 --qpmax 81” representing that quantified parameters are controlled to range from 0 to 81; “--scenecut 50” representing that calculating a measurement value for each frame, to estimate the level of difference with the previous frame, wherein if the value is lower than a given scenecut value, it will be considered the occurrence of a scene change, this frame will be predetermined to be an IDR frame that can be any type of frames in the vide source (e.g. I frame, P frame, B frame or the like), and the position of this IDR frame will be recorded in the statistical file. During this encoding process, a set-up bitrate control mode, quantified parameters, an allocation decision algorithm of B frames, or the like can also be used to insert a frame in each second video clip or discard a frame in each second video clip and record types and positions of inserted and discarded frame.

After that, the scene switching position of the video is determined according to the predetermined frame type of the statistical file. The scene switching position is determined according to the positions predetermined as the IDR frames in the statistical file. In a video, video content is continuous and has high correlation if there is no scene change, but video contents before and after a scene change occurs has low correlation therebetween. Therefore, the division to a video can be made according to the correlation of contents by referring to the predetermined positions of IDR frames.

Then, all the first video clips are spliced to produce third video clips according to the scene switching position. When a certain first video clip includes the position predetermined as the IDR frame in the statistical file, splicing will start at this clip, and clips to be spliced will be successively found and spliced according to the order of generating the first video clips until a next position predetermined as the IDR frame exists a certain next first video clip in the statistical file; and thus, a third video clip will formed. In this way, all the first video clips are spliced to produce third video clips according to the positions predetermined as IDR frames, thereby carrying out logical video clips based on the correlation of video content.

For example, the positions in the statistical file predetermined as IDR frames are the 0^{th}, 50^{th}, 90^{th}, 150^{th}, and so on, A first video clip A obtained in the first video clips includes 30 frames, a first video clip B includes 40 frames, a first video clip C includes 30 frames, a first video clip D includes 40 frames, a first video clip E includes 40 frames, and so on. The first video clip A includes the position (the 0^{th} frame) that is predetermined as the IDR frame, so splicing can start from the first video clip A; if the first video clip B also includes the position (the 50^{th} frame) that is predetermined as the IDR frame, splicing can stop at the first video clip B; and the first video clip A and the first video clip B are spliced to produce a third video clip. If the first video clip C includes the position (the 90^{th} frame) predetermined as the IDR frame, another splicing starts from the first video clip C; since the first video clip D does not include the position predetermined as the IDR frame, the splicing will keep going; and if the first video clip E also includes the position (the 150^{th} frame) predetermined as the IDR frame, this splicing will end at the first video clip E and the first video clips C, D and E will be spliced to produce another third video clip. The others can be deduced by analogy.

Finally, all the third video clips are encoded and spliced to produce a complete video file according to the result information of frame rate conversion. During this encoding, the position predetermined as the IDR frame is encoded as an IDR frame, inserting or discarding a frame is done in the position of the frame to be inserted or discarded. After encoding, the IDR frame of the video appears in the position where a scene change occurs, and thus, the user will not sense any change in the image quality under the same scene when logical video clips are spliced after encoded. During this encoding, the outputted video can be set in a preset video format, e.g. --output “output.mkv” “input.avi”, the format of code flow of an input video is .avi, and the format of code flow of an output video is .mkv.

The video transcoding method provided in this embodiment is based on transcoding of logical video clips and can stand on the basis of logical video clips (dividing clips according to their content) to enhance the efficiency of transcoding clips and assure the quality of transcoding as much as possible; and since the whole video is scanned during the frame rate conversion analysis performed onto the video, the scanning result is absolutely the same as the calculating result of frame rate conversion during the transcoding of the entire clip. This avoids the errors possibly occurring to the conventional manner of transcoding video clips. Also, the frame rate conversion analysis is done only one time, and this conversion result will be repeatedly used by the follow-up 1 pass and 2 pass encodings, unlike physical video clips, for which the analysis has to be performed during each pass. This also saves transcoding time and greatly enhances the efficiency of transcoding videos.

Moreover, dividing first video clips by the positions of the IDR frames will have no need to divide a video before the follow-up splicing and encoding processes are done, and will only need to combine these clips. Since the combination of clips saves more time than dividing the video, the efficiency of video clips is enhanced; such a division done in the positions of IDR further stems from the feature of video decoding, where division performed in the position of IDR also stems from the feature of video decoding, which starts decoding from IDR, so as to ensure the proper decoding. A video source is divided for encoding according to the correlation of video content, and frames belonging to a scene are allocated between two IDR frames. Thus, the user will not sense any change in the image quality under the same scene when logical video clips are spliced after encoded.

### Embodiment 2

In this embodiment, the video transcoding method is similar to the Embodiment 1, but the first video clips are decapsulated data rate information.

In this embodiment, the first video clips are stored as decapsulated data without its container format. In the follow-up process, the video transcoding device 100 in this embodiment will not only waste transcoding time but also have errors if decapsulation is done in every transcoding. It is because decoding is applied to a code flow and the container format is omitted. The process of encoding a generated video is a re-encapsulation process, and sometimes errors may occur to this re-encapsulation process and cause the abnormal transcoding. Therefore, storing first video clips as decapsulated data can efficiently avoid the above problem and enhance the entire process efficiency.

### Embodiment 3

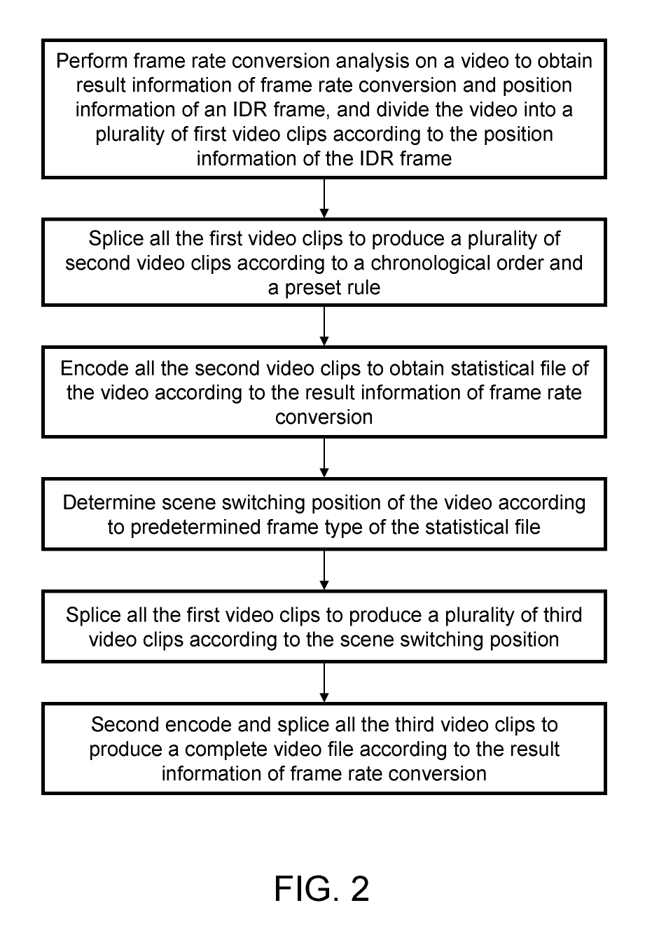

In this embodiment, as shown in FIG. 2, the video transcoding method is similar to the Embodiment 1, but the step of encoding and splicing all the third video clips to produce a complete video file according to the result information of frame rate conversion includes:
Second encoding and splicing all the third video clips to produce the complete video file according to the result information of frame rate conversion.

Second encoding respectively includes the first encoding (pass1) and the second encoding (pass2), and the use of second encoding can cause the outputted video has a better bitrate.

For example, under a target bitrate, statistical information is generated for each frame during the first encoding and can help each frame in the second encoding to find the best quantified parameter, and thus, the bitrate distribution curve can be improved and the quality of watching the video can be enhanced.

For example, the first encoding has a constitution expressed as:
x264_64_tMod-8bit-all.exe --input-csp i420 --output-csp i420 --level 4.1 --crf 23.5 --threads 18 --bframes 6 --chroma-qp-offset 3 --psy-rd 1.05:0.10 --b-adapt 2 --ref 5 --qcomp 0.7 --keyint 600 --deblock 1:1 --no-mbtree --scenecut 50 --fgo 0 --aq-mode 3 --aq-strength 1.0 --qpmin 0 --qpmax 81 --merange 24 --me umh --direct auto --subme 10 --partitions all --trellis 2 --stylish --pass 1 --stats “log.stat” --slow-firstpass --input-depth 8 --output NUL “input.avi”;
the second encoding has another constitution expressed as:
x264_64_tMod-8bit-all.exe --input-csp i420 --output-csp i420 --level 4.1 --bitrate 2000 --threads 18 --bframes 6 --chroma-qp-offset 3 --psy-rd 1.05:0.10 --b-adapt 2 --ref 5 --qcomp 0.7 --keyint 600 --deblock 1:1 --no-mbtree --scenecut 50 --fgo 0 --aq-mode 3 --aq-strength 1.0 --qpmin 0 --qpmax 81 --merange 24 --me umh --direct auto --subme 10 --partitions all --trellis 2 --stylish --pass 2 --stats “log.stat” --input-depth 8 --output “output.mkv” “input.avi”.

The first encoding uses a constant-rate-factor (CRF) mode to fine a proper quantified parameter and output a statistical file for each frame on the premise that the visual quality of human eyes is assured. The second encoding uses a constant target bitrate mode, e.g. 2000 kbps, in concert with a proper quantified parameter of each frame obtained in the first encoding, to assure the image quality of the output video and control the size of the output video to not exceed a certain limitation.

Typically, the second encoding spends more time than the single-pass encoding, so for a target with a higher bitrate, e.g. more than 450 kbps, the video outputted in the second encoding has better video quality; and for a target with a lower bitrate, e.g. less than 450 kbps, there is no obvious distinction between the video qualities of the second encoding and the single-pass encoding so that the single-pass encoding in this situation has a higher speed and high encoding efficiency.

### Embodiment 4

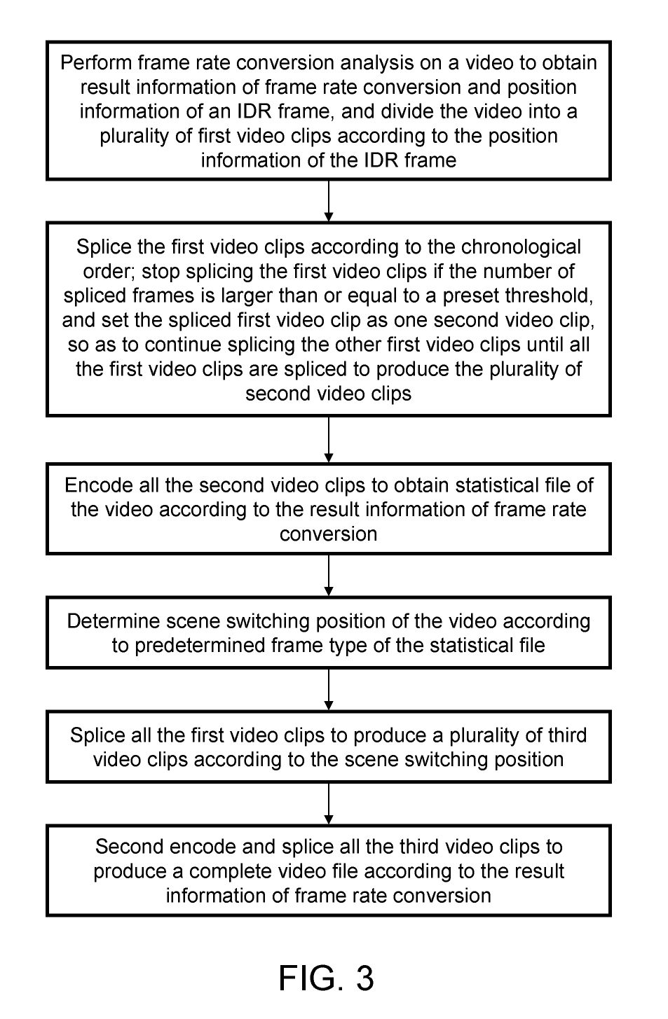

In this embodiment, as shown in FIG. 3, the video transcoding method is similar to the Embodiment 1, but the step of splicing all the first video clips to produce a plurality of second video clips according to the chronological order and the preset rule includes:
successively splicing the first video clips according to the chronological order, stopping splicing the first video clips if the number of spliced frames is larger than or equal to a preset threshold, and setting the spliced first video clip as one second video clip, so as to continue splicing the other first video clips until all the first video clips are spliced to produce a plurality of second video clips.

The threshold of the number of frames in the spliced first video clips can be in concert with the number of cluster apparatuses of transcoding and the transcoding time. For example, 3000 frames are used as an example, so if the number of frames in the spliced first video clips is larger than or equal to 3000 frames, the splicing process stops and a splicing process for a next second video clip starts. What the splicing process concerns is: each first video clip will delivered to a cluster apparatus of transcoding if no clip is spliced; the finite number of apparatuses in the cluster causes a certain video needs to stand in a queue for transcoding; and a first video clip with the insufficient number of reference frames causes lower encoding performance. If the number of spliced frames is too much, the transcoding time of each second video clip will become too long, and this means that the advantage of segmentation transcoding is not used well. Therefore, it is necessary to select a threshold of the number of spliced frames according to actual factors such as the number of cluster apparatuses of transcoding and the transcoding time for accomplishing transcoding, so as to fully exploit the advantages of segmentation transcoding and fully use a cluster apparatus of transcoding to accomplish a transcoding task in high efficiency.

### Embodiment 5

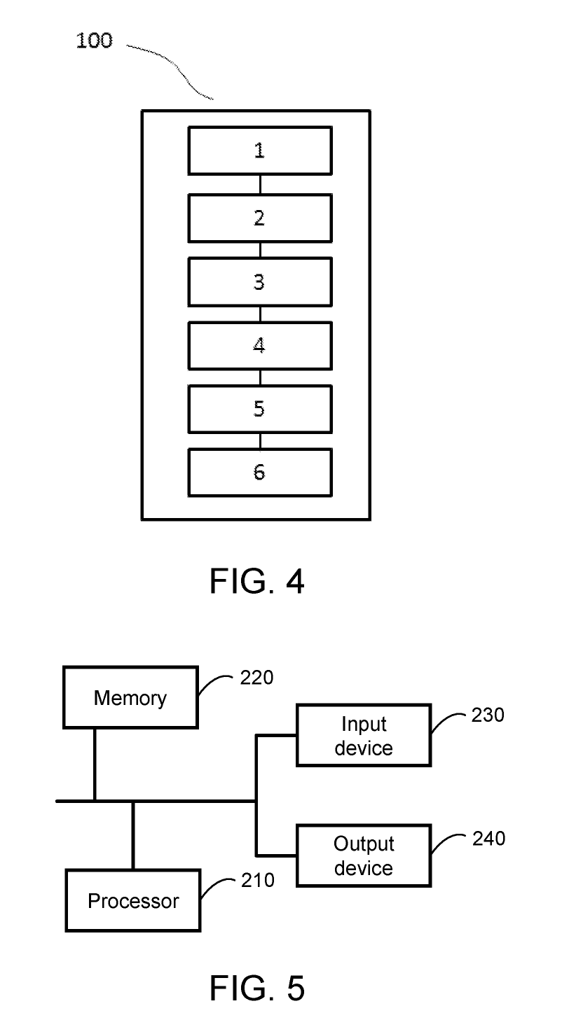

In this embodiment, as shown in FIG. 4, a video transcoding device 100 includes:
a video processing module 1 configured to perform frame rate conversion analysis on a video to obtain result information of frame rate conversion and position information of an IDR frame, and divide the video into a plurality of first video clips according to the position information of the IDR frame;
a first splicing module 2 configured to splice all the first video clips to produce a plurality of second video clips according to chronological order and preset rule;
a first encoding module 3 configured to encode all the second video clips to produce a statistical file of the video according to the result information of frame rate conversion;
a determining module 4 configured to determine scene switching position of the video according to predetermined frame type of the statistical file;
a second splicing module 5 configured to splice all the first video clips to produce a plurality of third video clips according to the scene switching position;
a second encoding module 6 configured to encode and splice all the third video clips to produce a complete video file according to the result information of frame rate conversion.

The video processing module 1 is connected to the second encoding module 6 via the first splicing modules 2, the first encoding module 3, the determining module 4 and the second splicing module 5, successively. In this embodiment, the video transcoding method is based on transcoding of logical video clips and can stand on the basis of logical video clips (dividing clips according to their content) to enhance the efficiency of transcoding clips and assure the quality of transcoding as much as possible; and since the whole video is scanned during the frame rate conversion analysis performed onto the video, the scanning result is absolutely the same as the calculating result of frame rate conversion during the transcoding of the entire clip. This avoids the errors possibly occurring to the conventional manner of transcoding video clips. Dividing first video clips in the positions of IDR frames has no need to divide the video before the follow-up splicing and encoding processes, it is only needed to combine these clips, and the combination time is fewer than the time of division, and thus the efficiency of video clips is enhanced. Division performed in the position of IDR also stems from the feature of video decoding, which starts decoding from IDR, so as to ensure the proper decoding. A video source is divided for encoding according to the correlation of video content, and frames belonging to a scene are allocated between two IDR frames. Thus, the user will not sense any change in the image quality under the same scene when logical video clips are spliced after encoded.

### Embodiment 6

In this embodiment, a video transcoding device 100 is similar to the Embodiment 5, but the first video clips are decapsulated data rate information.

In the follow-up process, the video transcoding device 100 in this embodiment will not only waste transcoding time but also have errors if decapsulation is done in every transcoding. It is because decoding is applied to a code flow and the container format is omitted. The process of encoding a generated video is a re-encapsulation process, and sometimes errors may occur to this re-encapsulation process and cause the abnormal transcoding. Therefore, storing first video clips as decapsulated data can efficiently avoid the above problem and enhance the entire process efficiency.

### Embodiment 7

In this embodiment, the video transcoding device 100 is similar to the Embodiment 5, but the second encoding module 6 includes:
an encoding sub-module configured to second encode and splice all the third video clips to produce the complete video file according to the result information of frame rate conversion.

The second encoding module 6 in the video transcoding device 100 of this embodiment uses second encoding, to improve the bitrate distribution curve and enhance the quality of watching the video.

### Embodiment 8

In this embodiment, the video transcoding device 100 is similar to the Embodiment 5, but the first splicing module 2 includes:
a splicing sub-module configured to successively splice the first video clips according to the chronological order, stop splicing the first video clips if the number of spliced frames is larger than or equal to a preset threshold, and set the spliced first video clip as one second video clip, so as to continue splicing the other first video clips until all the first video clips are spliced to produce a plurality of second video clips.

It causes the video transcoding device 100 can fully exploit the advantages of segmentation transcoding and fully use cluster apparatus of transcoding to accomplish a transcoding task in high efficiency.

Moreover, this embodiment may employ hardware processor to carry out the above functional modules.

### Embodiment 9

This embodiment provides a non-volatile computer storage medium storing computer executable instructions used to perform the video transcoding method in any method embodiment.

### Embodiment 10

As shown in FIG. 5, an embodiment of the disclosure provides an electronic apparatus of video transcoding, including:
one or more processors 210, wherein there is exemplarily one processor 210 in FIG. 5;
a memory 220 configured to store instructions executable by the processor 210;
wherein the processor 210 is configured to:
   perform frame rate conversion analysis on a video to obtain result information of frame rate conversion and position information of an IDR frame, and dividing the video into a plurality of first video clips according to the position information of the IDR frame;
   splice all the first video clips to produce a plurality of second video clips according to chronological order and preset rule;
   encode all the second video clips to produce statistical file of the video according to the result information of frame rate conversion;
   determine scene switching position of the video according to predetermined frame type of the statistical file;
   splice all the first video clips to produce a plurality of third video clips according to the scene switching position;
   encode and splice all the third video clips to produce a complete video file according to the result information of frame rate conversion.

In an embodiment, the first video clips are decapsulated data rate information.

In an embodiment, the step of encoding and splicing all the third video clips to produce the complete video file according to the result information of frame rate conversion includes:
second encoding and splicing all the third video clips to produce the complete video file according to the result information of frame rate conversion.

In an embodiment, the step of splicing all the first video clips to produce a plurality of second video clips according to the chronological order and the preset rule includes:
successively splicing the first video clips according to the chronological order, stopping splicing the first video clips if the number of spliced frames is larger than or equal to a preset threshold, and setting the spliced first video clip as one second video clip, so as to continue splicing the other first video clips until all the first video clips are spliced to produce a plurality of second video clips.

The electronic apparatus for performing the video transcoding method further includes: an input device 230 and an output device 240.

The processor 210, the memory 220, the input device 230 and the output device 240 can be connected to each other via a bus or other manners, and FIG. 5 exemplarily illustrates a bus is used to connect these elements.

The memory 220 is a non-volatile computer-readable storage medium for storing non-volatile software programs, non-volatile computer-executable programs and modules; for example, the program instructions and the function modules (e.g. the video processing module 1, the first splicing module 2, the first encoding module 3, the determination module 4, the second splicing module 5 and the second encoding module 6 as shown in FIG. 4) corresponding to the processing method in the embodiments. The processor 210 executes function applications and data processing of the server, i.e. the video transcoding method in the method embodiments, by running the non-volatile software programs, non-volatile computer-executable programs and modules stored in the memory 220.

The memory 220 can include a program storage area and a data storage area, wherein the program storage area can store an operating system and at least one application program required for a function; the data storage area can store the data created according to the use of a processing device of video transcoding. Furthermore, the memory 220 can include a high speed random-access memory, and further include a non-volatile memory such as at least one disk storage member, at least one flash memory member and other non-volatile solid state storage member. In some embodiments, the memory 220 can be selected from memories having a remote connection with the processor 210, and these remote memories can be connected to a processing device of video transcoding by a network. The aforementioned network includes, but not limited to, internet, intranet, local area network, mobile communication network and combination thereof.

The input device 230 can receive digital or character information, and generate a key signal input corresponding to the user setting and the function control of the processing device of video transcoding. The output device 240 can include a display apparatus such as a screen.

The one or more modules are stored in the memory 220, and the one or more modules execute the video transcoding method in any of the above embodiments when executed by the one or more processors 210.

The aforementioned product can execute the method in the embodiments of the disclosure, and has functional modules and beneficial effect corresponding to the execution of the method. The technical details not described in the embodiments can be referred to the method provided in the embodiments of the disclosure.

The electronic apparatus in the embodiments of the present application is presence in many forms, and the electronic apparatus includes, but not limited to:
(1) mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.
(2) ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.
(3) portable entertainment apparatus: this type of apparatus can display and play multimedia contents. This type of apparatus includes: audio, video player (e.g. iPod), handheld game console, e-books, as well as smart toys and portable vehicle-mounted navigation apparatus.
(4) server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.
(5) other electronic apparatus having a data exchange function.

The described apparatus embodiment is merely exemplary. The units described as separate parts may or may not be physically separate, and parts displayed as units may or may not be physical units, that is, may be located in one position, or may be distributed on a plurality of network units. A part or all of the modules may be selected according to actual needs to achieve the objectives of the solutions of the embodiments. A person of ordinary skill in the art may understand and implement the technical solution without creative works.

With the description of the above embodiments, those skilled in the art can understand clearly that, the methods according to the above embodiments can be implemented by means of software plus a necessary general-purpose hardware platform, and of course can be implemented by hardware. Based on such understanding, the technical solutions of the present disclosure essentially or a part of the technical solutions of the present disclosure which makes contribution to the related art can be embodied in a form of a software product, and the computer software product is stored in a computer readable storage medium, such as a ROM/RAM, a magnetic disc, an optical disk or the like, and includes some instructions to cause a computer apparatus which may be a personal computer, a server, network equipment, or the like to implement the method or a part of the method according to the respective embodiments.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions recorded in the foregoing embodiments or make equivalent replacements to part of technical features of the technical solutions recorded in the foregoing embodiments; however, these modifications or replacements do not make the essence of the corresponding technical solutions depart from the spirit and scope of the technical solutions of the embodiments of the present invention.

What is claimed is:

1. A video transcoding method, applied to a terminal and comprising:
performing frame rate conversion analysis on video to obtain result information of frame rate conversion and position information of an IDR frame, and dividing the video into a plurality of first video clips according to the position information of the IDR frame;
splicing all the first video clips to produce a plurality of second video clips according to chronological order and preset rule;
encoding all the second video clips to obtain statistical file of the video according to the result information of frame rate conversion;
determining scene switching position of the video according to predetermined frame type of the statistical file;
splicing all the first video clips to produce a plurality of third video clips according to the scene switching position;
encoding and splicing all the third video clips to produce a complete video file according to the result information of frame rate conversion.

2. The method according to claim 1, wherein the first video clips are decapsulated data rates.

3. The method according to claim 1, wherein encoding and splicing all the third video clips to produce the complete video file according to the result information of frame rate conversion comprises:
second encoding and splicing all the third video clips to produce the complete video file according to the result information of frame rate conversion.

4. The method according to claim 1, wherein splicing all the first video clips to produce the plurality of second video clips according to chronological order and preset rule comprises:
successively splicing the first video clips according to the chronological order, stopping splicing the first video clips if the number of spliced frames is larger than or equal to a preset threshold, and setting the spliced first video clip as one second video clip, so as to continue splicing the other first video clips until all the first video clips are spliced to produce the plurality of second video clips.

5. A non-volatile computer storage medium storing computer-executable instructions used to perform:
performing frame rate conversion analysis on video to obtain result information of frame rate conversion and position information of an IDR frame, and dividing the video into a plurality of first video clips according to the position information of the IDR frame;
splicing all the first video clips to produce a plurality of second video clips according to chronological order and preset rule;
encoding all the second video clips to obtain statistical file of the video according to the result information of frame rate conversion;
determining scene switching position of the video according to predetermined frame type of the statistical file;
splicing all the first video clips to produce a plurality of third video clips according to the scene switching position;
encoding and splicing all the third video clips to produce a complete video file according to the result information of frame rate conversion.

6. The non-volatile computer storage medium according to claim 5, wherein the first video clips are decapsulated data rates.

7. The non-volatile computer storage medium according to claim 5, wherein encoding and splicing all the third video clips to produce the complete video file according to the result information of frame rate conversion comprises:
second encoding and splicing all the third video clips to produce the complete video file according to the result information of frame rate conversion.

8. The non-volatile computer storage medium according to claim 5, wherein splicing all the first video clips to produce the second video clips according to chronological order and preset rule comprises:
successively splicing the first video clips according to the chronological order, stopping splicing the first video clips if the number of spliced frames is larger than or equal to a preset threshold, and setting the spliced first video clip as one second video clip, so as to continue splicing the other first video clips until all the first video clips are spliced to produce the plurality of second video clips.

9. An electronic apparatus, comprising:
at least one processor;
a memory configured to store instructions executable by the processor;
wherein the processor is configured to:
perform frame rate conversion analysis on a video to obtain result information of frame rate conversion and position information of an IDR frame, and dividing the video into a plurality of first video clips according to the position information of the IDR frame;
splice all the first video clips to produce a plurality of second video clips according to chronological order and preset rule;
encode all the second video clips to produce statistical file of the video according to the result information of frame rate conversion;
determine scene switching position of the video according to predetermined frame type of the statistical file;
splice all the first video clips to produce a plurality of third video clips according to the scene switching position;
encode and splice all the third video clips to produce a complete video file according to the result information of frame rate conversion.

10. The electronic apparatus according to claim 9, wherein the first video clips are decapsulated data rate information.

11. The electronic apparatus according to claim 9, wherein the processor is configured to:
second encode and splice all the third video clips to produce the complete video file according to the result information of frame rate conversion.

12. The electronic apparatus according to claim 9, wherein the processor is configured to:
successively splice the first video clips according to the chronological order, stop splicing the first video clips if the number of spliced frames is larger than or equal to a preset threshold, and set the spliced first video clip as one second video clip, so as to continue splicing the other first video clips until all the first video clips are spliced to produce the plurality of second video clips.
